(19) United States
(12) Patent Application Publication
(10) Pub. No.: US 2024/0352978 A1
(43) Pub. Date: Oct. 24, 2024

(54) DRAG REDUCTION CLUTCH PLATES WITH SPRING RETURN FEATURE

(71) Applicant: GM GLOBAL TECHNOLOGY OPERATONS LLC, Detroit, MI (US)

(72) Inventors: Julio Cesar MARTINEZ FRAUSTO, Sterling Heights, MI (US); Chad Robert BRIZENDINE, Fenlon, MI (US)

(21) Appl. No.: 18/305,128

(22) Filed: Apr. 21, 2023

(51) Int. Cl. F16D 13/56; F16D 13/64

(52) U.S. Cl. CPC F16D 13/56; F16D 13/644

(57) ABSTRACT

A clutch plate includes a disk-shaped plate having an outer perimeter edge and a center opening having an inner perimeter edge, one of the outer perimeter edge and the inner perimeter edge including splines circumferentially there along, the disk-shaped plate having a first side face and a second side face each including a friction surface configured to engage a first opposing clutch plate, the disk-shaped plate having a plurality of return springs integrally formed in the disk-shaped plate, the plurality of return springs being bent to extend outward from a surface of one of the first side face and the second side face.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a clutch system and more particularly to clutch plates having spring return features for reducing drag.

Disc clutches, such as rotating-type clutches and brake-type clutches used in transmissions, have sets of closely spaced plates that are selectively engageable with one another to transmit torque loads. The plates generate significant amounts of heat, and require cooling and lubrication. The lubricated plates tend to generate drag, causing considerable spin losses.

### SUMMARY

According to an aspect of the present disclosure, a clutch plate includes a disk-shaped plate having an outer perimeter edge and a center opening having an inner perimeter edge, one of the outer perimeter edge and the inner perimeter edge including splines circumferentially there along, the disk-shaped plate having a first side face and a second side face each including a friction surface configured to engage a first opposing clutch plate, the disk-shaped plate having a plurality of return springs integrally formed in the disk-shaped plate, the plurality of return springs being bent to extend outward from a surface of one of the first side face and the second side face.

According to a further aspect, the plurality of return springs include a first plurality of return springs extending in a first direction from the first side face and a second plurality of return springs extending from the second side face in a second direction, opposite to the first direction.

According to a further aspect, the plurality of return springs each include a spring tab formed from a respective cut-out in the disk-shaped plate.

According to a further aspect, the spring tabs are bent to extend outward from the cut-out region above a surface of one of the first and second side faces.

According to a further aspect, the spring tabs include an engagement surface that is substantially parallel to the first and second side faces and spaced from one of the first and second side faces.

According to a further aspect, a first plurality of the plurality of spring tabs are bent to extend outward above a surface of the first side face and a second plurality of the plurality of spring tabs are bent to extend outward above a surface of the second side face.

According to a further aspect, the first plurality of the plurality of spring tabs include an engagement surface that is substantially parallel to the first side face and the second plurality of the plurality of spring tabs include an engagement surface that is substantially parallel to the first side face.

According to yet another aspect of the present disclosure, a clutch system includes a clutch hub having a first splined surface and a clutch housing having a second splined surface. A plurality of inner clutch plates include a first disk-shaped plate having an outer perimeter edge and a center opening having an inner perimeter edge including a third splined surface engaging the first splined surface, the plurality of inner clutch plates each having a first side face and a second side face each including a first friction surface. A plurality of outer clutch plates are interleaved alternatively with the plurality of inner clutch plates, the plurality of outer clutch plates including a second disk-shaped plate having an outer perimeter edge including a fourth splined surface engaging the second splined surface and a center opening having an inner perimeter edge, the plurality of outer clutch plates each having a first side face and a second side face each including a second friction surface, the second friction surface of the plurality of outer plates are configured to engage a corresponding first friction surface of an adjacent one of the plurality of inner clutch plates. The plurality of inner clutch plates further include a plurality of return springs integrally formed in the first disk-shaped plate, the plurality of return springs each being bent to extend outward from a surface of one of the two side faces and engage an adjacent one of the plurality of inner clutch plates.

According to a further aspect, the plurality of return springs include a first plurality of return springs extending in a first direction from a first side face of the plurality of inner clutch plates and a second plurality of return springs extending from the second side face in a second direction, opposite to the first direction.

According to a further aspect, the plurality of return springs each include a spring tab formed from a respective cut-out in the plurality of inner clutch plates.

According to a further aspect, the spring tabs are bent to extend outward from the cut-out region above a surface of one of the first side face and the second side face.

According to a further aspect, the spring tabs include an engagement surface that is substantially parallel to the first and second side faces and spaced from one of the first and second side faces.

According to a further aspect, a first plurality of the plurality of spring tabs are bent to extend outward above a surface of the first side face of the plurality of inner clutch plates and a second plurality of the plurality of spring tabs are bent to extend outward above a surface of the second side face of the plurality of inner clutch plates.

According to a further aspect, the first plurality of the plurality of spring tabs include an engagement surface that is substantially parallel to the first side face of the inner clutch plate and the second plurality of the plurality of spring tabs include an engagement surface that is substantially parallel to the first side face of the inner clutch plate.

According to a further aspect, the third splined surface and the first splined surface are keyed to align the plurality of return springs of the inner clutch plates with the plurality of return springs of adjacent one of the inner clutch plates.

According to a further aspect, the plurality of return springs each being bent to extend outward from a surface of one of the two side faces and engage a corresponding one of the plurality of return spring of an adjacent one of the plurality of inner clutch plates.

According to yet another aspect of the present disclosure, a clutch system includes a clutch hub having a first splined surface and a clutch housing having a second splined surface. A plurality of inner clutch plates include a first disk-shaped plate having an outer perimeter edge and a center opening having an inner perimeter edge including a third splined surface engaging the first splined surface, the plurality of inner clutch plates each having a first side face and a second side face each including a first friction surface. A plurality of outer clutch plates are interleaved alternatively with the plurality of inner clutch plates, the plurality of outer clutch plates including a second disk-shaped plate having an outer perimeter edge including a fourth splined surface engaging the second splined surface and a center opening having an inner perimeter edge, the plurality of outer clutch plates each having a first side face and a second side face each including a second friction surface, the second friction surface of the plurality of outer plates are configured to engage a corresponding first friction surface of an adjacent one of the plurality of inner clutch plates. The plurality of outer clutch plates include a plurality of return springs integrally formed in the second disk-shaped plate, the plurality of return springs each being bent to extend outward from a surface of one of the two side faces and engage an adjacent one of the plurality of outer clutch plates.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side plan view of a clutch plate having integral spring features for drag reduction according to the principles of the present disclosure;

FIG. 2 is a detailed cross-sectional view of the integral spring feature of the clutch plate according to the principles of the present disclosure; and

FIG. 3 is a schematic view of a clutch system incorporating integral spring features on the inner clutch plates according to the principles of the present disclosure;

FIG. 4 is a schematic view of a clutch system incorporating integral spring features on the outer clutch plates according to the principles of the present disclosure; and

FIG. 5 is a detailed cross-sectional view of the interface between corresponding spring return features of adjacent clutch plates.

In the drawings, reference numbers may be reused to identify similar and/or identical elements.

### DETAILED DESCRIPTION

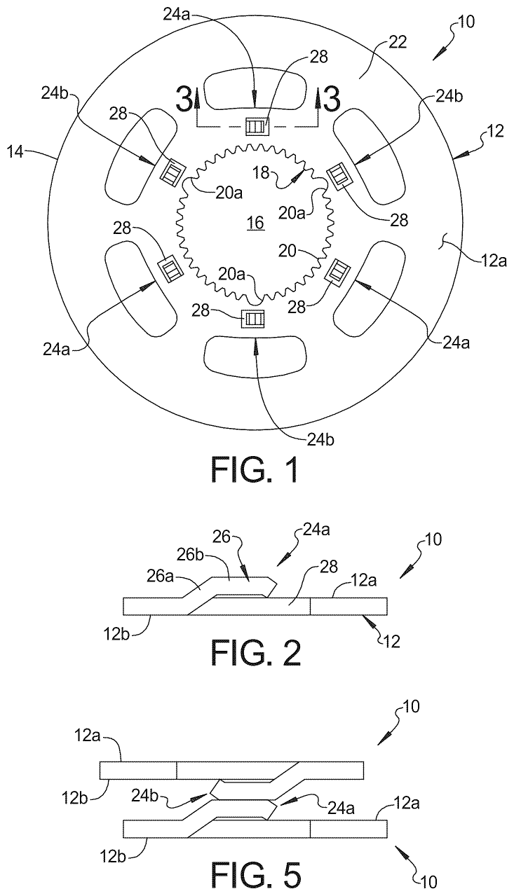

With reference to FIG. 1, a clutch plate 10 for use in a clutch system will now be disclosed. The clutch plate 10 includes a disk-shaped plate 12 having an outer perimeter edge 14 and a center opening 16 having an inner perimeter edge 18. In the example embodiment shown, inner perimeter edge 18 includes splines 20 circumferentially there along and the clutch plate is an inner clutch plate. It should be understood that the principles of the present disclosure can equally be applied to an outer clutch plate with splines on an outer perimeter edge as will be shown with reference to FIG. 4 herein. The disk-shaped plate 12 includes a first side face 12a and a second side face 12b each including a friction surface region 22 configured to engage an opposing outer clutch plate, as will be described further herein. The disk-shaped plate 12 further includes a plurality of return spring features 24 integrally formed in the disk-shaped plate 12. As best shown in FIG. 2, the plurality of return spring features 24 can be formed as a bent tab 26 in a cut-out 28 in the disk-shaped plate 12 which extends outward from a surface of one of the first side face 12a and the second side face 12b. The cut-out 28 can be U-shaped, as shown and the bent tabs 26 can be cantilevered with an angled support portion 26a and can include an engagement surface 26b that can be bent to be substantially parallel to the first and second side faces 12a, 12b and spaced from one of the first and second side faces 12a, 12b. Alternatively, the cutout can be a pair of parallel cuts and the return spring features 24 can be pressed/stretched outward from either of the first side face 12a and the second side 12b to form a stretched flexible spring member.

The plurality of return spring features 24 include a first plurality of return springs 24a extending in a first direction from the first side face 12a and a second plurality of return springs 24b extending from the second side face 12b in a second direction, opposite to the first direction. In the embodiment shown, the clutch plate 10 includes six return spring features 24 including three return spring features 24a that extend upward from the first side face 12a, and three return spring features 24b that extend upward from the second side face 12b.

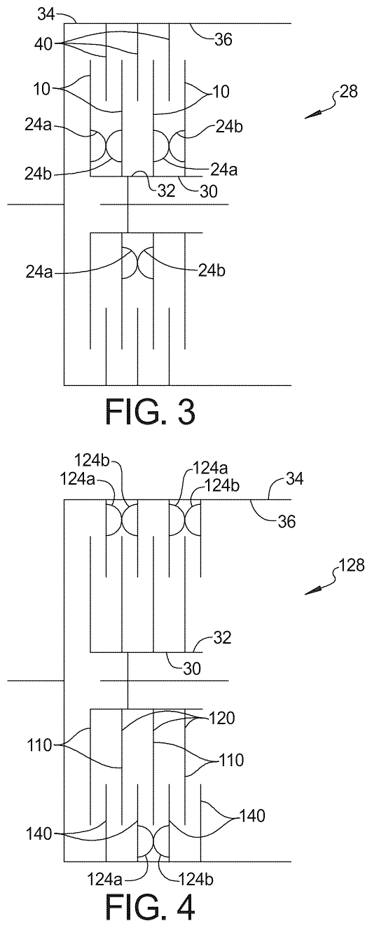

With reference to FIG. 3, an example clutch system 28 is shown including a clutch hub 30 having an exterior splined surface 32 and a clutch housing 34 having an interior splined surface 36. A plurality of inner clutch plates 10 are mounted on the clutch hub 30 with their splines 20 engaged with the exterior splined surface 32. A plurality of outer clutch plates 40 are interleaved with the inner clutch plates 10 and include an outer splined surface engaging the interior splined surface 36 of the clutch housing. The plurality of inner clutch plates 10 each include a friction surface 22 opposing a corresponding friction surface of the outer clutch plates 40. The plurality of inner clutch plates 10 include a plurality of return spring features 24a, 24b integrally formed in the disk-shaped plate 12. In the assembled condition, the return spring features 24a of an inner clutch plate are designed to engage a corresponding return spring feature 24b of an adjacent inner clutch plate 10, as shown in FIG. 5, in order to press the inner clutch plates apart when an engagement force is not applied to the clutch system. By maintaining a spacing between the clutch plates when an engagement force is not being applied, drag friction of the clutch system 28 can be reduced or avoided. The splines 20 of the inner clutch plates and the exterior splined surface 32 of the clutch hub can be keyed with one or more uniquely shaped and located spline teeth 20a (see for example, FIG. 1) to insure proper alignment of the return spring features 24a, 24b of adjacent clutch plates 10.

With reference to FIG. 4, an example clutch system 128 is shown including a clutch hub 30 having an exterior splined surface 32 and a clutch housing 34 having an interior splined surface 36. A plurality of inner clutch plates 110 are mounted on the clutch hub 30 with their splines 120 engaged with the exterior splined surface 32. A plurality of outer clutch plates 140 are interleaved with the inner clutch plates 110 and include an outer splined surface engaging the interior splined surface 36 of the clutch housing. The plurality of inner clutch plates 110 each include a friction surface opposing a corresponding friction surface of the outer clutch plates 140. The plurality of outer clutch plates 140 include a plurality of return spring features 124a, 124b integrally formed in the disk-shaped plate. In the assembled condition, the return spring features 124a of an outer clutch plate 140 are designed to engage a corresponding return spring feature 124b of an adjacent outer clutch plate 140, as shown in FIG. 5, in order to press the inner clutch plates apart when an engagement force is not applied to the clutch system. By maintaining a spacing between the clutch plates when an engagement force is not being applied, drag friction of the clutch system 128 can be reduced or avoided. The splines of the outer clutch plates 140 and the interior splined surface 36 of the clutch housing 34 can be keyed with one or more uniquely shaped and located spline teeth to insure proper alignment of the return spring features 124a, 124b of adjacent outer clutch plates 140.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

1. A clutch plate comprising:
a disk-shaped plate having an outer perimeter edge and a center opening having an inner perimeter edge, one of the outer perimeter edge and the inner perimeter edge including splines circumferentially there along, the disk-shaped plate having a first side face and a second side face each including a friction surface configured to engage a first opposing clutch plate, the disk-shaped plate having a plurality of return springs integrally formed in the disk-shaped plate, the plurality of return springs being bent to extend outward from a surface of one of the first side face and the second side face, wherein the plurality of return springs each include a spring tab formed from a respective plurality of U-shaped cut-outs in the disk-shaped plate, the plurality of U-shaped cut-outs being spaced radially inward from the outer perimeter edge and spaced radially outward from the inner perimeter edge.

2. The clutch plate according to claim 1, wherein the plurality of return springs include a first plurality of return springs extending in a first direction from the first side face and a second plurality of return springs extending from the second side face in a second direction, opposite to the first direction.

3. (canceled)

4. The clutch plate according to claim 1, wherein the spring tabs are bent to extend outward from the cut-out region above a surface of one of the first and second side faces.

5. The clutch plate according to claim 4, wherein the spring tabs include an engagement surface that is substantially parallel to the first and second side faces and spaced from one of the first and second side faces.

6. The clutch plate according to claim 1, wherein a first plurality of the plurality of spring tabs are bent to extend outward above a surface of the first side face and a second plurality of the plurality of spring tabs are bent to extend outward above a surface of the second side face.

7. The clutch plate according to claim 6, wherein the first plurality of the plurality of spring tabs include an engagement surface that is substantially parallel to the first side face and the second plurality of the plurality of spring tabs include an engagement surface that is substantially parallel to the first side face.

8. A clutch system, comprising:
a clutch hub having a first splined surface;
a clutch housing having a second splined surface;
a plurality of inner clutch plates including a first disk-shaped plate having an outer perimeter edge and a center opening having an inner perimeter edge including a third splined surface engaging the first splined surface, the plurality of inner clutch plates each having a first side face and a second side face each including a first friction surface; and
a plurality of outer clutch plates interleaved alternatively with the plurality of inner clutch plates, the plurality of outer clutch plates including a second disk-shaped plate having an outer perimeter edge including a fourth splined surface engaging the second splined surface and a center opening having an inner perimeter edge, the plurality of outer clutch plates each having a first side face and a second side face each including a second friction surface, the second friction surface of the plurality of outer plates are configured to engage a corresponding first friction surface of an adjacent one of the plurality of inner clutch plates,
wherein the plurality of inner clutch plates include a plurality of return springs integrally formed in the first disk-shaped plate, the plurality of return springs each being bent to extend outward from a surface of one of the two side faces and engage an adjacent one of the plurality of inner clutch plates, wherein the plurality of return springs each include a spring tab formed from a respective plurality of U-shaped cut-outs in the plurality of inner clutch plates, the plurality of U-shaped cut-outs being spaced radially inward from the outer perimeter edge and spaced radially outward from the inner perimeter edge.

9. The clutch system according to claim 8, wherein the plurality of return springs include a first plurality of return springs extending in a first direction from a first side face of the plurality of inner clutch plates and a second plurality of return springs extending from the second side face in a second direction, opposite to the first direction.

10. (canceled)

11. The clutch system according to claim 8, wherein the spring tabs are bent to extend outward from the cut-out region above a surface of one of the first side face and the second side face.

12. The clutch system according to claim 11, wherein the spring tabs include an engagement surface that is substantially parallel to the first and second side faces and spaced from one of the first and second side faces.

13. The clutch system according to claim 8, wherein a first plurality of the plurality of spring tabs are bent to extend outward above a surface of the first side face of the plurality of inner clutch plates and a second plurality of the plurality of spring tabs are bent to extend outward above a surface of the second side face of the plurality of inner clutch plates.

14. The clutch system according to claim 13, wherein the first plurality of the plurality of spring tabs include an engagement surface that is substantially parallel to the first side face of the inner clutch plate and the second plurality of the plurality of spring tabs include an engagement surface that is substantially parallel to the first side face of the inner clutch plate.

15. The clutch system according to claim 8, wherein the third splined surface and the first splined surface are keyed to align the plurality of return springs of the inner clutch plates with the plurality of return springs of adjacent one of the inner clutch plates.

16. The clutch system according to claim 8, the plurality of return springs each being bent to extend outward from a surface of one of the two side faces and engage a corresponding one of the plurality of return spring of an adjacent one of the plurality of inner clutch plates.

17. A clutch system, comprising:
a clutch hub having a first splined surface;
a clutch housing having a second splined surface;
a plurality of inner clutch plates including a first disk-shaped plate having an outer perimeter edge and a center opening having an inner perimeter edge including a third splined surface engaging the first splined surface, the plurality of inner clutch plates each having a first side face and a second side face each including a first friction surface; and
a plurality of outer clutch plates interleaved alternatively with the plurality of inner clutch plates, the plurality of outer clutch plates including a second disk-shaped plate having an outer perimeter edge including a fourth splined surface engaging the second splined surface and a center opening having an inner perimeter edge, the plurality of outer clutch plates each having a first side face and a second side face each including a second friction surface, the second friction surface of the plurality of outer plates are configured to engage a corresponding first friction surface of an adjacent one of the plurality of inner clutch plates,
wherein the plurality of outer clutch plates include a plurality of return springs integrally formed in the second disk-shaped plate, the plurality of return springs each being bent to extend outward from a surface of one of the two side faces and engage an adjacent one of the plurality of outer clutch plates, wherein the plurality of return springs each include a spring tab formed from a respective plurality of U-shaped cut-outs in the plurality of outer clutch plates, the plurality of U-shaped cut-outs being spaced radially inward from the outer perimeter edge and spaced radially outward from the inner perimeter edge.

18. The clutch system according to claim 17, wherein the plurality of return springs include a first plurality of return springs extending in a first direction from a first side face of the plurality of outer clutch plates and a second plurality of return springs extending from the second side face in a second direction, opposite to the first direction.

19. (canceled)

20. The clutch system according to claim 17, wherein the spring tabs are bent to extend outward from the cut-out region above a surface of one of the first side face and the second side face.
